(19) United States
(12) Patent Application Publication
(10) Pub. No.: US 2005/0136900 A1
(43) Pub. Date: Jun. 23, 2005

(54) Transcoding apparatus and method

(76) Inventors: Hyun Woo Kim, Seoul (KR); Eung Don Lee, Daejeon-city (KR); Do Young Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/866,122

(22) Filed: Jun. 10, 2004

(30) Foreign Application Priority Data
Dec. 22, 2003 (KR) 2003-94422

(51) Int. Cl. H04Q 7/20

(52) U.S. Cl. 455/414.4; 455/432.2

(57) ABSTRACT

Provided are a transcoding apparatus and method. A frame comparator compares the length of input frames of a transmitting side with the length of output frames of a receiving side. A frame deciding unit decides more than one input frame corresponding to one output frame on the basis of the comparison result and decides the type of the output frame based on the type of the corresponding input frame. A frame converter converts the format of the input frames to the format of the output frames on the basis of the decided type. Accordingly, a frame coded by a voice coder using VAD is easily transformed to the format of another voice coder.

### BACKGROUND OF THE INVENTION

This application claims the priority of Korean Patent Application No. 2003-94422, filed on Dec. 22, 2003, in the Korean Intellectual Property Office, the disclosure of which is incorporated herein in its entirety by reference.

1. Field of the Invention

The present invention relates to a transcoding apparatus and method and, more particularly, to a transcoding apparatus and method for transforming a frame coded by a voice coder to a format of another voice coder using voice activity detection (VAD).

2. Description of the Related Art

Voice transmission using digital technology has been popularized. Accordingly, techniques of minimizing of the quantity of information transmitted through a channel while maintaining recognition quality of a synthesized voice are increasingly studied. When a voice is simply sampled, quantized and transmitted, a data transmission rate of 64 Kbps is required in order to achieve the conventional telephone sound quality.

However, with the introduction of various voice processing techniques, the quantity of information can be reduced through an appropriate coding operation of a transmitting side and a synthesizing operation of a receiving side. An apparatus using voice compression is called a voice coder. The voice coder includes an encoder that divides an input signal into time blocks and analyzes them to extract parameters, and a decoder that synthesizes a voice using the parameters transmitted through a channel.

Furthermore, the voice coder uses voice activity detection (VAD) that discriminates a voice signal from a non-voice signal for each frame in order to save a bandwidth and power. A general voice coder system using VAD is a discrete transmission system that does not transmit data for each frame but transmits the data periodically or non-periodically.

There are a variety of kinds of voice coders. To operate communication systems having different formats, conversion from one coding format to another coding format is required. That is, a voice transcoding process that converts a bit stream coded by one voice coder to a bit stream of another voice coder is needed.

The voice transcoding technique includes a tandem method that decodes a bit stream coded by a coder and then codes the decoded bit stream through the other party's coder. The voice transcoding technique also includes a tandemless method that directly converts parameters because of a reduction in the quantity of calculations and sound quality in the voice transcoding process. However, conventional tandemless method is used between voice coders that do not use VAD.

Frames of a coder are divided into a voice section and a non-voice section when it passes through the VAD procedure. While every frame is transmitted during the voice section, a silence insertion descriptor (SID) is partially transmitted during the non-voice section in order to produce a background noise similar to an actual background noise with the minimum quantity of transmission. Types of coded frames are divided into a voice, a SID, and a non-voice that is not a SID (referred to as a non-voice hereinafter). The transcoding procedure executed between voice coders using VAD requires a process of deciding the type of a frame when the frame is transformed to another coding format. However, there has not been proposed any method.

### SUMMARY OF THE INVENTION

The present invention provides a transcoding apparatus and method for deciding the type of a frame when the frame is transformed to other formats during a transcoding procedure in order to provide interoperability between voice coding systems using VAD.

According to an aspect of the present invention, there is provided a transcoding apparatus comprising a frame comparator that compares the length of input frames of a transmitting side with the length of output frames of a receiving side; a frame deciding unit that judges at least one input frame corresponding to one output frame on the basis of the comparison result and decides the type of the output frame based on the type of the corresponding input frame; and a frame converter that converts the format of the input frames to the format of the output frames on the basis of the decided type.

According to another aspect of the present invention, there is provided a transcoding method comprising comparing the length of input frames of a transmitting side with the length of output frames of a receiving side; judging at least one input frame corresponding to one output frame on the basis of the comparison result and deciding the type of the output frame based on the type of the corresponding input frame; and converting the format of the input frames to the format of the output frames on the basis of the decided type.

Accordingly, a frame coded by a voice coder using VAD is easily transformed to the format of another voice coder.

### BRIEF DESCRIPTION OF THE DRAWINGS

The above and other features and advantages of the present invention will become more apparent by describing in detail exemplary embodiments thereof with reference to the attached drawings in which:

FIG. 1a shows a transcoding apparatus according to an embodiment of the present invention;

FIG. 1b shows the configuration of the transcoding apparatus according to the present invention;

FIG. 2 is a diagram for explaining a method of deciding an output frame type when a frame length of a transmitting voice coder is identical to that of a receiving voice coder;

FIG. 3 is a diagram for explaining a method of deciding an output frame type when a frame length of a transmitting voice coder is longer than that of a receiving voice coder;

FIG. 4 is a diagram for explaining a method of deciding an output frame type when a frame length of a transmitting voice coder is shorter than that of a receiving voice coder; and

FIG. 5 shows a flow chart of a transcoding method according to an embodiment of the present invention.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

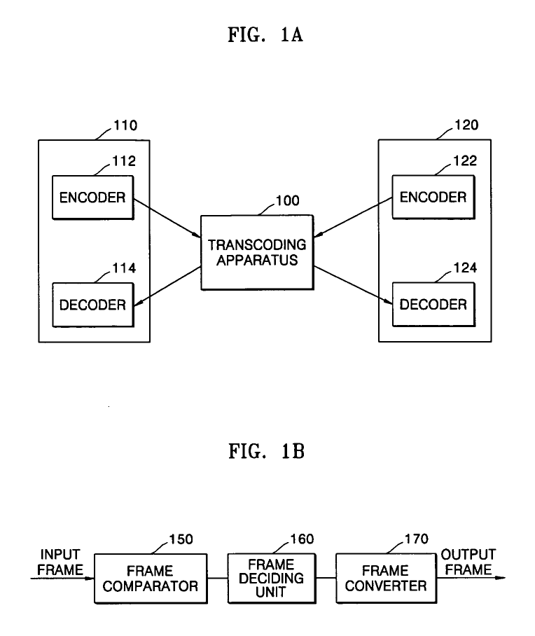

FIG. 1a shows a transcoding apparatus according to an embodiment of the present invention. Referring to FIG. 1a, the transcoding apparatus 100 of the invention converts a frame format between voice coders 110 and 120. That is, the transcoding apparatus 100 decides the type of an output frame based on the type of an input frame and converts the format of the input frame to the format of the output frame on the basis of the decided type between the two voice coders 110 and 120 using VAD.

The voice coders 110 and 120 respectively include encoders 112 and 122 that divide an input voice signal into time blocks and analyze them to extract parameters and decoders 114 and 124 that synthesize a voice using the parameters transmitted through channels.

Frames of each of the voice coders 110 and 120 using VAD are divided into a voice section and a non-voice section. While every frame is transmitted during the voice section, a silence insertion descriptor (SID) is partially transmitted during the non-voice section in order to produce a background noise similar to an actual background noise with the minimum quantity of transmission. The types of frames coded by the voice coders include a voice, a SID, and a non-voice that is not a SID (referred to as non-voice hereinafter).

FIG. 1b shows the configuration of the transcoding apparatus according to the present invention. Referring to FIG. 1b, the transcoding apparatus 100 includes a frame comparator 150, a frame deciding unit 160, and a frame converter 170.

The frame comparator 150 compares the length of a frame (referred to as “input frame” hereinafter) of the voice coder 110 at a transmitting side with the length of a frame (referred to as “output frame” hereinafter) of the voice coder 120 at a receiving side. Frame types of the transmitting and receiving voice coders 110 and 120 include the voice, SID, and non-voice.

The frame deciding unit 160 decides the type of the output frame based on the comparison result and the type of the input frame. The voice coders 110 and 120 have different frame lengths. Thus, the number of input frames corresponding to one output frame is varied according to whether the frame length of the transmitting voice coder 110 and the frame length of the receiving voice coder 120 are identical to each other or different from each other. Accordingly, the frame deciding unit 160 judges the number of input frames corresponding to one output frame on the basis of the comparison result of the frame comparator 150. When there are at least two input frames correspond to one output frame, the frame deciding unit 160 decides a type having higher priority among the types of the input frames as the type of the output frame. The priority of the frame types is in the order of the voice, SID and non-voice.

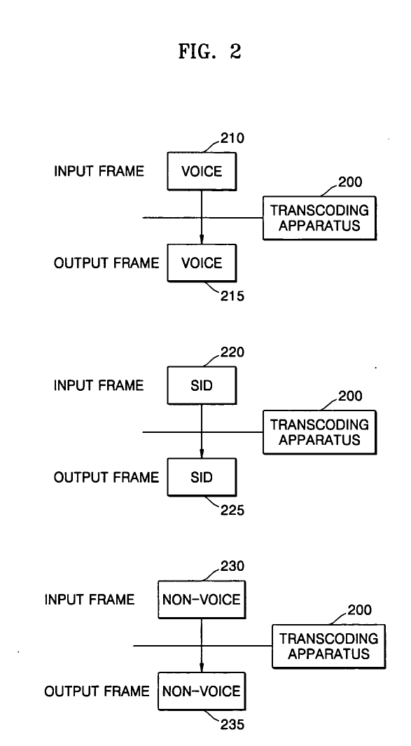

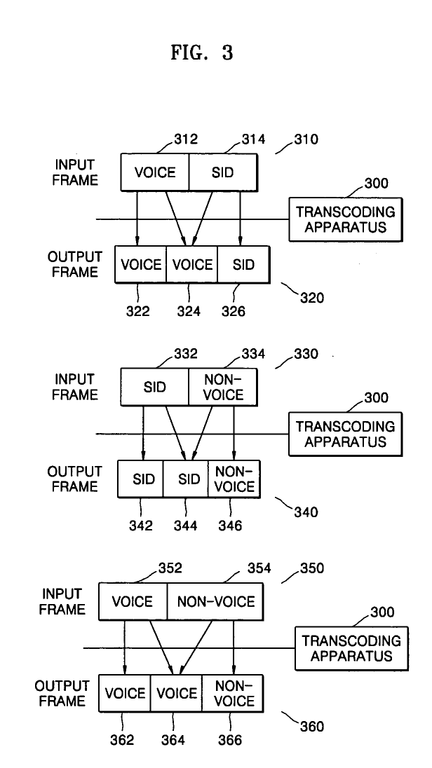

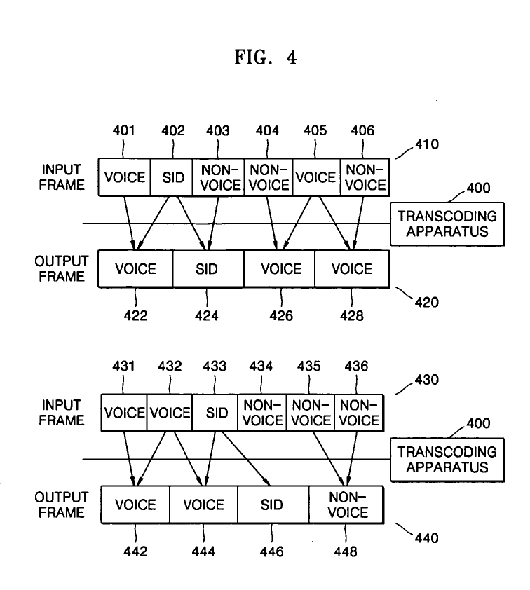

A procedure of deciding the output frame type of the receiving voice coder 120 based on the frame type of the transmitting voice coder 110 is explained with reference to FIGS. 2, 3 and 4. FIG. 2 is a diagram for explaining a method of deciding an output frame type when an input frame length is identical to an output frame length, and FIG. 3 shows the case that the input frame length is longer than the output frame length. FIG. 4 shows the case that the input frame length is shorter than the output frame length.

Referring to FIG. 2, the length of input frames 210, 220 and 230 of the transmitting voice coder 110 is identical to the length of output frames 215, 225 and 235 of the receiving voice coder 120. In this case, the frame comparator of the transcoding apparatus 200 compares the length of the input frames 210, 220 and 230 with the length of the output frames 215, 225 and 235 to recognize that they are identical to each other. The frame deciding unit of the transcoding apparatus 200 makes the input frames 210, 220 and 230 correspond to the output frames 214, 224 and 234 one to one and decides the types of the input frames as the types of the output frames. Specifically, the type of the output frame 215 is decided as a voice when the type of the input frame 210 is a voice, and the type of the output frame 225 is decided as a SID when the type of the input frame is a SID. Furthermore, the type of the output frame 235 is decided as a non-voice when the type of the input frame is a non-voice.

The frame converter of the transcoding apparatus 200 converts the format of the input frames 210, 220 and 230 to the format of the output frames 215, 225 and 235 on the basis of the decided types. That is, the frame converter converts the format of the input frames 210, 220 and 230 to the forms of parameters (LSP or ISP, pitch, gain and so on) of the receiving voice coder.

FIG. 3 is a diagram for explaining the method of deciding the output frame type when the frame length of the transmitting voice coder is longer than that of the receiving voice coder. Referring to FIG. 3, the length of input frames 310, 330 and 350 is longer than the length of output frames 320, 340 and 360. The frame comparator of the transcoding apparatus 300 compares the length of the input frames 310, 330 and 350 with the length of the output frames 320, 340 and 360 to recognize that the length of the input frames is longer than the length of the output frames 320, 340 and 360. In this case, each input frame corresponds to more than one output frame. In the temporal comparison of the input frames with the output frames, each output frame is included in one input frame or overlapped with portions of consecutive two input frames. That is, one output frame corresponds to a part of one input frame or parts of at least two input frames.

When each output frame corresponds to parts of at least two input frames, the frame deciding unit of the transcoding apparatus 300 decides a type having higher priority among the types of the corresponding input frames as the type of the output frame. When each output frame corresponds to a part of one input frame, the frame deciding unit decides the type of the corresponding input frame as the type of the output frame.

For example, the types of two continuous input frames 312 and 314 are a voice and a SID, respectively, and there are three consecutive output frames 322, 324 and 326 corresponding to the two input frames 312 and 314. Here, the first output frame 322 corresponds to a part of the first input frame 312, and the second output frame 324 corresponds to a part of the first input frame 312 and a part of the second input frame 314. The third output frame 326 corresponds to a part of the second input frame 314.

Since there is only one input frame 312 corresponding to the first output frame 322, the frame deciding unit of the transcoding apparatus 300 decides the type of the first input frame 312, that is the voice, as the type of the first output frame 322. When there are two input frames 312 and 314 corresponding to the second output frame 324 and the types of the input frames 312 and 314 are a voice and a SID, respectively, the voice has the priority higher than that of the SID. Accordingly, the frame deciding unit of the transcoding apparatus 300 decides the type of the first input frame 312, that is the voice, as the type of the second output frame 324. The third output frame 326 corresponds to only the second input frame 314. Thus, the frame deciding unit of the transcoding apparatus 300 decides the type of the second input frame 314, that is the SID, as the type of the third output frame 326.

When an output frame 344 corresponds to parts of two input frames 332 and 334 whose types are a SID and a non-voice, respectively, the frame deciding unit of the transcoding apparatus 300 decides the SID having higher priority as the type of the output frame 344.

Furthermore, when an output frame 364 corresponds to parts of two input frames 352 and 354 whose types are a voice and a non-voice, respectively, the frame deciding unit of the transcoding apparatus 300 decides the voice having higher priority as the type of the output frame 364.

FIG. 4 is a diagram for explaining the method of deciding the output frame type when the frame length of the transmitting voice coder is shorter than that of the receiving voice coder.

Referring to FIG. 4, the length of input frames 410 and 430 is shorter than the length of output frames 420 and 440. The frame comparator of the transcoding apparatus 400 compares the length of the input frames 410 and 430 with the length of the output frames 420 and 440 to recognize that the length of the input frames 410 and 430 is shorter than the length of the output frames 420 and 440. In this case, each output frame corresponds to more than one input frame because the length of each input frame is shorter than the length of each output frame.

When there are more than two input frames that correspond to each output frame, the frame deciding unit of the transcoding apparatus 400 decides a type having higher priority among the types of the corresponding input frames as the type of the output frame.

For example, the types of consecutive input frames 401 through 406 are a voice, a SID, a non-voice, a non-voice, a voice and a non-voice, respectively, and the first one of consecutive output frames 422, 424, 426 and 428 corresponds to the first and second input frames 401 and 402. In addition, the second output frame 424 corresponds to the second and third input frames 402 and 403, the third output frame 426 corresponds to the fourth and fifth input frames 404 and 405, and the fourth output frame 428 corresponds to the fifth and sixth input frames 405 and 406.

Accordingly, the frame deciding unit of the transcoding apparatus 400 decides a type having higher priority among the types of the input frames 401 and 402 corresponding to the first output frame 422 as the type of the output frame 422. In this manner, the frame deciding unit decides the types of the second, third and fourth output frames.

Exceptionally, when an output frame 444 corresponds to two input frames 432 and 433 whose types are a voice and a SID, respectively, the type of the output frame 444 is decided as the voice according to the priority. However, when the type of the following output frame 446 is judged to be a non-voice, the type of the previous output frame 444, that is the SID, is decided as the type of the following output frame 446.

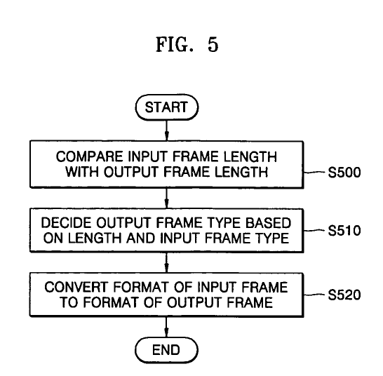

FIG. 5 is a flow chart of a transcoding method according to the present invention.

Referring to FIG. 5, the frame comparator 150 compares a frame length of the transmitting voice coder with that of the receiving voice coder in step 500. The frame deciding unit 160 judges input frames corresponding to output frames on the basis of the comparison result. When the length of the output frames is identical to the length of the input frames, the output frames correspond to the input frames one to one. When they are different from each other, each output frame corresponds to more than two consecutive input frames.

When there are more than two input frames corresponding to one output frame, the frame deciding unit 160 decides a type having higher priority among the types of the corresponding input frames as the type of the output frame in step S510.

The frame converter 170 converts the format of the input frames to the format of the output frames on the basis of the decided type in step S520.

The present invention can be embodied by computer-readable codes in a computer-readable medium. The computer-readable medium includes recording devices that store data readable by a computer system, for example, a ROM, RAM, CD-ROM, magnetic tape, floppy disc, optical data storage device and so on. The computer-readable medium further includes a medium constructed in the form of carrier wave (for example, transmission through the Internet). Furthermore, the computer-readable medium can be distributed in computer systems connected through a network to store and execute computer-readable codes in a distributed manner.

While the present invention has been particularly shown and described with reference to exemplary embodiments thereof, it will be understood by those of ordinary skill in the art that various changes in form and details may be made therein without departing from the spirit and scope of the present invention as defined by the following claims.

As described above, the present invention can easily decide the type of an output frame using the type of an input frame when the input frame coded by a voice coder using VAD is transformed the format of another voice coder. Furthermore, the present invention can easily construct a transcoding apparatus and reduce the quantity of calculations.

1. A transcoding apparatus comprising:
a frame comparator that compares the length of input frames of a transmitting side with the length of output frames of a receiving side;
a frame deciding unit that decides more than one input frame corresponding to one output frame on the basis of the comparison result and decides the type of the output frame based on the type of the corresponding input frame; and
a frame converter that converts the format of the input frames to the format of the output frames on the basis of the decided type.

2. The transcoding apparatus as claimed in claim 1, wherein, when there are more than two input frames corresponding to one output frame, the frame deciding unit decides a type having higher priority among the types of the corresponding input frames as the type of the output frame.

3. The transcoding apparatus as claimed in claim 2, wherein the priority is in the order of a voice, a SID and a non-voice.

4. The transcoding apparatus as claimed in claim 1, wherein, when the length of the input frames is identical to the length of the output frames, the frame deciding unit judges that the input frames correspond to the output frames one to one.

5. The transcoding apparatus as claimed in claim 1, wherein, when the length of the input frames is different from the length of the output frames, the frame deciding unit judges that each output frame corresponds to more than one input frame.

6. A transcoding method comprising:
comparing the length of input frames of a transmitting side with the length of output frames of a receiving side;
deciding more than one input frame corresponding to one output frame on the basis of the comparison result and deciding the type of the output frame based on the type of the corresponding input frame; and
converting the format of the input frames to the format of the output frames on the basis of the decided type.

7. The transcoding method as claimed in claim 6, wherein, when there are more than two input frames corresponding to one output frame, a type having higher priority among the types of the corresponding input frames is decided as the type of the output frame.

8. The transcoding method as claimed in claim 7, wherein the priority is in the order of a voice, a SID and a non-voice.
